(19) United States
(12) Patent Application Publication
(10) Pub. No.: US 2007/0213197 A1
(43) Pub. Date: Sep. 13, 2007

(54) Aqua blue glass composition with increased infrared absorption

(76) Inventors: Edward N. Boulos, Troy, MI (US); James V. Jones, Nashville, TN (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/374,393

(22) Filed: Mar. 13, 2006

(51) Int. Cl. C03C 3/087

(52) U.S. Cl. 501/70; 501/71

(57) ABSTRACT

A glass composition has a base and a colorant. The composition of the base is 68 to 75% SiO₂, 10 to 18 wt. % Na₂O, 5 to 15 wt. % CaO, 0 to 10 wt. % MgO, 0 to 5 wt. % Al₂O₃, and 0 to 5 wt. % K₂O, where CaO+MgO is 6 to 15 wt. % and Na₂O+K₂O is 10 to 20 wt. % is provided. The composition of the colorants comprises 0.4 to 0.6 wt. % Fe₂O₃, 0.18 to 0.28 wt. % FeO, 0.05 to 0.3 wt. % MnO₂, and 0 to 8 ppm Cobalt. The redox ratio of the weight of FeO to the total weight of iron is in a range of about 0.40 to about 0.58. The colored glass has an aqua color with a dominant wavelength of 489.2 nm +/−1.2 nm, an excitation purity of 7% +/−1%, and an infrared transmittance in the range of 16% to 29% at 4.0 mm thickness.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to a composition for automotive and architectural glass, and, more specifically, to high transmittance aqua blue glass with high infrared absorption that is made using a process that provides an increased proportion of iron in the reduced form.

Window-type glass is manufactured mainly for automotive applications (e.g., windshields and backlights) and architectural applications (e.g., windows and doors of buildings and homes). Although many of the desired properties for automotive and architectural glass are very similar, the glass compositions typically used in each field of application have been quite different. It would be extremely advantageous to improve the infrared absorption of glass products while maintaining a high level of visible transmission and to also have a good absorption in the ultraviolet portion of the spectrum to simultaneously meet the needs of both automotive and architectural applications.

Automotive glass must provide a very good transmittance of visible light while significantly blocking infrared light. Regulations require an automotive glass (except in trucks behind the B-pillar) to provide a 70% transmittance using illuminant A (LTA). Glass for vehicles is typically a laminate having two thin glass plies with a clear plastic interlayer, and the combined layers must meet the transmittance level. These demands have typically been met using a tinted glass having a green coloration. However, this color fails to meet the needs of most architectural applications. In addition, it would be desirable to improve styling options for vehicle manufacturers by providing an aqua blue glass with sufficient visible transmittance together with high levels of infrared and ultraviolet absorption.

Choosing an architectural glass for buildings puts more emphasis on the color of the glass and its physical/mechanical characteristics. Although clear glass is often used, it would be desirable in many cases to utilize an aqua blue color for its aesthetic and optical properties.

The batch ingredients of a glass composition include some basic ingredients (e.g., sand, soda ash, etc.) together with additives for determining various properties of the glass. One well known additive is iron. Iron oxide exists in two chemical forms in the glass, an oxidized form (Fe₂O₃) which is yellow and a reduced form (FeO) which is blue. Advantageously, the oxidized form of iron oxide absorbs a portion of the ultraviolet light passing through the glass product and the reduced form of iron oxide absorbs a portion of the infrared light passing through the glass product. Under typical furnace firing conditions and batching conditions, when the total iron oxide in the glass product is within the range of about 0.2 to 1.2 wt. % as Fe₂O₃, the iron oxide equilibrium is such that the redox ratio of FeO/total Fe as Fe₂O₃ is about 0.18-0.26.

It is desirable to increase the proportion of reduced iron oxide (FeO) in the glass to improve its infrared absorption. In addition, by shifting the iron oxide away from the oxidized form (Fe₂O₃) the glass will change color from green to blue. The aqua blue glass of the present invention is achieved by shifting the iron equilibrium to a much higher proportion of the reduced form of iron and maintaining it throughout the glass making process.

One way commonly employed to shift the redox equilibrium of iron oxide in the glass, and hence its UV and IR properties, is by increasing the fuel to the furnace. Increasing the amount of fuel, however, has several undesirable consequences: the combustion heating of the furnace becomes inefficient and requires an air increase or the unburnt fuel will burn in the checker system of the furnace. Excess fuel can also reduce the glass to an amber color that sharply lowers the visible transmittance of the glass product. An amber color arises when the iron reacts with sulfur that has been reduced to form iron sulfide. Amber colored glass containers are normally melted in like manner by using anthracite coal together with iron oxide and sulfate. The amber iron sulfide chromophore, once produced, significantly decreases the visible transmittance of the glass and the glass could not be used where a high transmittance is required. Therefore, there is a need in the glass industry to produce an aqua blue glass that has high transmittance yet having an improved infrared light absorption and an ultra violet absorption.

### SUMMARY OF THE INVENTION

In one aspect of the present invention an aqua blue glass having a base and a colorant is provided. The composition of the colorant by weight of the colored glass comprises 0.4 to 0.6 wt. % Fe₂O₃, 0.18 to 0.28 wt. % FeO, 0.05 to 0.3 wt. % MnO₂, and 0 to 8 ppm Cobalt, wherein a redox ratio of the weight of FeO to the total weight of iron is in a range of about 0.40 to about 0.58, and wherein the colored glass has an aqua color with a dominant wavelength of 489.2 nm +/−1.2 nm, an excitation purity of 7% +/−1%, and an infrared transmittance in the range of 16% to 29% at 4.0 mm thickness.

The glass composition of the present invention provides good visible transmittance while maintaining an aqua blue appearance and significantly lowering the ultraviolet and infrared transmittance, thereby making the glass desirable for both architectural and automotive applications. The particular aqua blue color may be adjusted by varying the amount of Cobalt (e.g., Cobalt oxide) within the specified range either through deliberate batch input or from the remnants of a previous batch of glass melted in the furnace in which the glass is being made using the well known float process.

### DETAILED DESCRIPTION OF PREFERRED EMBODIMENTS

Flat soda-lime-silica glass, used in the automotive and architectural industries and conveniently made by the float glass process, is generally characterized by the following basic composition, the amounts of the components being based on a weight percentage of the total glass composition:

TABLE I

| Base Glass Components | Weight % |
|---|---|
| SiO₂ | 68 to 75 |
| Al₂O₃ | 0 to 5 |
| CaO | 5 to 15 |
| MgO | 0 to 10 |
| Na₂O | 10 to 18 |
| K₂O | 0 to 5 |

The aqua blue glass composition of the present invention employs this basic soda-lime-silica glass composition wherein, additionally, CaO+MgO is 6 to 15 wt. % and Na₂O+K₂O is 10 to 20 wt. %. Preferably, SO₃ is present in an amount of 0.03 to 0.20 wt %, and more preferably, 0.03 to 0.10 wt. % in the final glass product. In addition, the aqua blue glass composition consists essentially of the following coloring components: iron oxide, manganese compound, and cobalt.

The total iron as Fe₂O₃ is present in the invention composition in quantities of 0.4 to 0.6 wt. % Fe₂O₃. Typically, this ingredient is added with the batch ingredients in the oxide form, i.e. Fe₂O₃. The iron oxide incorporated in the composition lowers both the ultraviolet and the infrared transmittance of the glass products. Iron oxide as used in normal commercial production has a redox ratio (defined as equal to the weight of FeO divided by the total iron) in the range of about 0.18-0.26. In contrast, the glass of the present invention has a higher redox ratio in the range of 0.4 to about 0.58 (and more preferably from about 0.45 to about 0.55). As the percent of FeO approaches 60% of the total iron oxide, the iron reacts with sulfate in the glass to produce a deep amber color which would be detrimental. Since sulfates are required to aid in removing gaseous inclusions from the glass in the molten state, the percent of FeO must be maintained in the given range. Care is taken to maintain the high proportion of reduced iron through the copious use of a reductant such as coal or graphite or through the introduction of the iron oxide into the batch in a highly reduced state.

The key to making glass of the invention is controlling the oxidation and reduction in the float process through the furnace operation and the batch additives. The batch includes sand, soda ash, salt cake, limestone, dolomite, nepheline syenite, rouge and a reductant such as anthracite coal or graphite and may include cobalt oxide and an oxidizer such as manganese dioxide. An admixture of the batch together with cullet (broken glass, preferably the same chemistry of the batch) and is fed continuously into the float furnace in regulated amounts. The base glass components including sand, soda ash, limestone, dolomite and nepheline syenite typically remain constant from one colored glass product to another. The other batch components are carefully controlled and variations are found from product to product. The salt cake, Na₂SO₄, or other sulfate component is added to the batch for fining control, i.e., removal of gaseous inclusions. Anthracite coal or graphite is added to cause the chemical disassociation of the salt cake or other sulfate than would normally occur thermally and which accelerates the fining process. Increasing the salt cake content will tend to slightly oxidize the iron. Increasing manganese dioxide will also oxidize the iron and will aid in preventing the formation of the amber color. The iron oxide equilibrium in glass of the invention is shifted by vastly increasing the concentration of the reductants in the batch mixture or by adding the iron already in the reduced form. When reduced iron cullet of the instant invention is used, the reductant must be increased in order to maintain the shift of iron oxide equilibrium toward the reduced iron. If oxidized cullet is used, the reductant must be added in a much larger quantity in order to shift the iron equilibrium in the cullet toward the reduced form.

A desired aqua blue color is obtained by choosing an amount of cobalt oxide either through deliberate batch input or from the remnants of a previous product melted in the furnace used to make glass of the invention. Manganese dioxide is used to aid in maintaining the equilibrium of the iron since it acts as an oxidizer and helps to prevent the amber formation.

The glass of the invention is manufactured by one step batch admixing of the components to feed a conventional SIEMENS float glass furnace. Sodium sulfate is mixed in the batch together with anthracite coal or graphite to shift the iron oxide equilibrium toward the reduced form of iron (FeO). Manganese dioxide is necessary in the batch to prevent the formation of the amber iron sulfide. All of the batch components are mixed together in a single step and then metered into the furnace.

A manganese compound is present in an amount of 0.05 to 0.3 wt. % based on MnO₂ in the glass composition. This manganese compound can be added to the batch glass components in a variety forms, e.g., but not limited to MnO₂, Mn₃O4, MnO, MnCO₃, MnSO₄, MnF₂, or MnCl₂, etc.

Table II discloses example amounts of raw material batch ingredients that are preferably used to form the aqua blue glass compositions according to the present invention.

TABLE II

| Batch Material | Range of Mass (lbs.) |
|---|---|
| Sand | 1000 |
| Soda Ash | 290 to 350 |
| Limestone | 70 to 90 |
| Dolomite | 215 to 260 |
| Salt cake | 2.5 to 11 |
| Rouge (97% Fe₂O₃) | 4.1 to 7.2 |
| Manganese Dioxide | 1.3 to 7.0 |
| Cobalt Oxide | 0 to 0.03 |
| Anthracite coal | 0.9 to 2.5 |

The anthracite coal can be bought under the trade-name CARBOCITE and is commercially available from the Shamokin Filler Company. Graphite is used as an alternative source of carbon with and without anthracite coal in the following examples. MELITE, a coal slag processed by Calumite Corporation could partially or wholly substitute for rouge in the batch up to about 55 pounds MELITE per 1000 pounds of sand. MELITE has about 80% of the total iron oxide in the reduced form and thus would require less anthracite coal to generate similar spectral properties. The purpose of each of these materials is to shift the iron redox ratio from its normal range of 0.18 to 0.26 up to a higher range from about 0.4 to about 0.58. The most preferred range for the present invention is from about 0.45 to about 0.55.

The equilibrium reactions that occur in the glass melt which causes a shift in the forms of iron oxide are influenced by the sodium sulfate used as a refining agent and carbon used to react with sodium sulfate at lower furnace temperatures. Generally, increasing the quantity of sodium sulfate in the glass tends to shift the iron oxide equilibrium slightly toward oxidizing. On the other hand, increasing carbon concentration in the glass batch shifts the iron oxide equilibrium toward reducing form of iron. Increasing the amount of manganese oxide shifts the iron oxide equilibrium again towards the oxide form. Another influence on the iron oxide equilibrium is the peak furnace temperature, which when increased will shift the iron oxide slightly toward the reduced state and when lowered will shift the iron oxide back towards the oxidized state.

Melts were made in the laboratory which demonstrate embodiments of this invention using the procedure as follows. Batches were weighed, placed into a glass jar about 2″ high and 2″ inside diameter, and dry mixed for 10 minutes each on a Turbula mixer. The dry batch was placed into an 80% platinum/20% rhodium crucible that stands 2″ tall and has an inside diameter at the top of 2.5″ and is tapered to the base which has an inside diameter of 1.75″. An amount of 4.5 ml. of water is added to the dry batch in the crucible and mixed with a metal spoon. After such preparation, a group of different batches is melted in a gas/air fired furnace at the same time for 1 hour at 2600° F. and each crucible is removed in turn from the furnace and fritted. Fritting the glass involves coating the inside of the platinum/rhodium crucible by rolling the molten glass around the inside of the crucible and then plunging the crucible into cold water. After removing the crucible from the water and draining, the broken glass particles are removed from the sides of the crucible and mechanically mixed inside the crucible. All samples are fritted in like manner and all crucibles are placed back into the furnace for another hour interval at 2600° F. and the fritting procedure is repeated. After the second fritting process, the crucibles are returned to the furnace for 4 hours at 2600° F. Each crucible is removed in turn from the furnace and each molten glass sample is poured into a graphite mold with an inside diameter of 2.5″. Each glass is cooled slowly, labeled, and placed into an annealing furnace where the temperature is quickly raised to 1050° F., held for 2 hours, and then slowly cooled by shutting off the furnace and removing the samples after 14 or more hours. The samples are ground and polished to about 4.0 mm. thickness and subsequently the spectral properties are measured for each sample.

All laboratory melts made with above procedure use a base composition of 100 grams sand, 32.22 grams soda ash, 8.81 grams limestone, 23.09 grams dolomite, 0.25 to 1.1 grams of sodium sulfate, 0.09 to 0.25 grams of CARBOCITE, 2.64 grams of nepheline syenite, and the remainder of the batch includes rouge, manganese dioxide, selenium and optionally cobalt oxide.

Each of the following tables of example glass compositions includes spectral data at 4.0 mm, which is the control thickness. The % LTA is defined to be the % luminance transmittance measured under CIE standard illuminant A. The dominant wavelength and the % excitation purity are measured using CIE standard illuminant C. The % UV is the % ultraviolet transmittance measured between 300 and 400 nanometers and % IR is the % infrared transmittance measured between 750 and 2100 nanometers.

Table III below provides example glass compositions of the instant invention for achieving an aqua blue color with enhanced ultraviolet and infrared absorption. All of the examples below are for batch only and the individual batch components of salt cake, anthracite coal and graphite are each in pounds per 1000 pounds of sand. The concentration of MnO₂ and FeO is in weight % of the glass product, the total iron concentration as weight % Fe₂O₃, and the Co is in ppm. The Redox Ratio is the ratio of % FeO divided by the total iron oxide as % Fe₂O₃. All of the spectral properties are at 4.0 mm. control thickness. LTA is the % light transmittance of the glass using Illuminant A. LTC is the % light transmittance using Illuminant C.

TABLE III

| | Example 1 | Example 2 | Example 3 | Example 4 | Example 5 |
|---|---|---|---|---|---|
| Salt Cake | 2.5 | 10.0 | 10.0 | 10.0 | 12.0 |
| Anthracite | 1.9 | 1.9 | 2.1 | 1.9 | 2.4 |
| Coal | | | | | |
| FeO | 0.230 | 0.272 | 0.246 | 0.222 | 0.263 |
| Fe₂O₃ | 0.402 | 0.501 | 0.451 | 0.451 | 0.480 |
| MnO₂ | 0.15 | 0.20 | 0.15 | 0.15 | 0.20 |
| Redox Ratio | 0.516 | 0.543 | 0.545 | 0.492 | 0.530 |
| LTA | 75.45 | 73.26 | 74.71 | 76.04 | 73.85 |
| LTC | 77.64 | 75.76 | 77.07 | 78.24 | 76.34 |
| Dominant | 489.8 | 489.9 | 489.7 | 489.6 | 489.3 |
| Wavelength | | | | | |
| Excitation | 6.5 | 7.6 | 7.1 | 6.6 | 7.8 |
| Purity, % | | | | | |
| % Ultra | 62.09 | 59.38 | 61.54 | 60.65 | 60.6 |
| Violet | | | | | |
| % Infra Red | 21.76 | 17.13 | 19.83 | 22.92 | 18.04 |
| % Total | 46.69 | 43.07 | 45.27 | 47.61 | 43.96 |
| Solar | | | | | |
| Energy | | | | | |

The aqua blue color represented by the dominant wavelength and excitation purity in the examples of Table III demonstrate glass products that would be indistinguishable from each other when viewed side by side at the same thickness. The following examples of the invention are also very close in color to those above despite the differences in chemistry used to produce them.

Table IV shows that graphite may replace anthracite coal as the reductant to shift the iron redox toward reducing.

TABLE IV

| | | | | | Example |
|---|---|---|---|---|---|
| | Example 6 | Example 7 | Example 8 | Example 9 | 10 |
| Salt Cake | 7.5 | 10.0 | 10.0 | 7.5 | 7.5 |
| Graphite | 1.7 | 1.47 | 1.25 | 2.35 | 1.9 |
| FeO | 0.215 | 0.258 | 0.245 | 0.259 | 0.222 |
| Fe₂O₃ | 0.433 | 0.601 | 0.601 | 0.502 | 0.503 |
| MnO₂ | 0.15 | 0.10 | 0.10 | 0.15 | 0.15 |
| Redox | 0.496 | 0.531 | 0.407 | 0.516 | 0.442 |
| Ratio | | | | | |
| LTA | 76.16 | 73.44 | 73.99 | 73.27 | 75.06 |
| LTC | 78.32 | 75.85 | 76.29 | 75.69 | 77.19 |
| Dominant | 489.5 | 489.7 | 489.7 | 489.9 | 490.0 |
| Wavelength | | | | | |
| Excitation | 7.1 | 7.4 | 7.0 | 7.4 | 6.3 |
| Purity, % | | | | | |
| % Ultra | 61.42 | 55.31 | 55.82 | 58.04 | 56.94 |
| Violet | | | | | |
| % Infra | 23.79 | 18.53 | 19.99 | 18.36 | 22.84 |
| Red | | | | | |
| % Total | 48.13 | 43.87 | 44.94 | 43.72 | 46.96 |
| Solar | | | | | |
| Energy | | | | | |

Table V below demonstrates the use of Calumite, Melite and iron pyrite to make glass of the instant invention. The amounts of Calumite, Melite and iron pyrite are all in pounds per 1000 pounds of sand. The Melite and iron pyrite replace the rouge normally used to provide the iron oxide source.

TABLE V

| | Example | Example | Example | Example | Example |
|---|---|---|---|---|---|
| | 11 | 12 | 13 | 14 | 15 |
| Salt Cake | 2.5 | 12.5 | 10.5 | | 2.5 |
| Anthracite | | | 1.15 | | |
| Coal | | | | | |
| Calumite | 40.0 | | | 40.0 | 80.0 |
| Melite | 34.7 | | 34.2 | | |
| Iron Pyrite | | 8.51 | | | |
| FeO | 0.248 | 0.243 | 0.237 | 0.229 | 0.219 |
| Fe₂O₃ | 0.503 | 0.501 | 0.499 | 0.502 | 0.499 |
| MnO₂ | 0.15 | 0.15 | 0.10 | 0.15 | 0.15 |
| Redox | 0.455 | 0.463 | 0.473 | 0.489 | 0.505 |
| Ratio | | | | | |
| LTA | 74.80 | 74.94 | 73.64 | 73.73 | 73.25 |
| LTC | 77.02 | 77.16 | 75.95 | 76.02 | 75.62 |
| Dominant | 490.2 | 489.5 | 489.9 | 489.9 | 490.0 |
| Wavelength | | | | | |
| Excitation | 6.6 | 6.8 | 7.0 | 6.9 | 7.2 |
| Purity, % | | | | | |
| % Ultra | 58.38 | 57.70 | 55.76 | 56.35 | 56.40 |
| Violet | | | | | |
| % Infra | 21.98 | 21.55 | 21.07 | 19.93 | 19.13 |
| Red | | | | | |
| % Total | 46.39 | 46.32 | 45.34 | 44.76 | 44.07 |
| Solar | | | | | |
| Energy | | | | | |

Table VI below demonstrates the impact of cobalt oxide on the color of the glass and the ability to maintain the color and the infrared absorption in glass of the present invention. Cobalt oxide is present in other known glass formulations, and these examples demonstrate that the color can be maintained with small amounts, thereby showing that a saleable product will be quickly obtained after introducing a different formulation in the furnace.

TABLE VI

| | Example | Example | Example | Example | Example |
|---|---|---|---|---|---|
| | 16 | 17 | 18 | 19 | 20 |
| Salt Cake | 2.5 | 7.5 | 2.5 | 7.5 | 2.5 |
| Graphite | | 1.7 | | 1.7 | 1.12 |
| Anthracite | 1.5 | | 1.5 | | |
| Coal | | | | | |
| FeO | 0.240 | 0.188 | 0.225 | 0.193 | 0.258 |
| Fe₂O₃ | 0.453 | 0.423 | 0.453 | 0.423 | 0.503 |
| MnO₂ | 0.15 | 0.15 | 0.15 | 0.15 | 0.15 |
| Co | 6.5 | 5.3 | 2.1 | 4.2 | 0 |
| Redox | 0.530 | 0.444 | 0.497 | 0.456 | 0.513 |
| Ratio | | | | | |
| LTA | 74.48 | 75.44 | 75.29 | 75.90 | 73.44 |
| LTC | 76.92 | 77.45 | 77.63 | 77.97 | 75.87 |
| Dominant | 488.2 | 488.5 | 488.6 | 488.6 | 489.2 |
| Wavelength | | | | | |
| Excitation | 8.0 | 6.5 | 7.4 | 6.6 | 7.7 |
| Purity, % | | | | | |
| % Ultra | 63.04 | 60.43 | 61.22 | 61.17 | 59.38 |
| Violet | | | | | |
| % Infra | 21.11 | 28.04 | 22.44 | 27.21 | 18.53 |
| Red | | | | | |
| % Total | 46.20 | 50.31 | 47.17 | 50.06 | 44.01 |
| Solar | | | | | |
| Energy | | | | | |

Table VII below below shows that the color and infrared absorption can be maintained when the manganese dioxide is varied in the batch. The manganese dioxide is used to keep the glass from becoming too reduced and to prevent the formation of the amber color. The amber color from the chemical combination of iron and sulfide would be generated once the redox ratio goes over 0.60. The amber color is very intense and besides shifting the color would significantly lower the visible transmittance below what would be acceptable for automotive applications.

TABLE VII

| | Example 21 | Example 22 | Example 23 | Example 24 |
|---|---|---|---|---|
| Salt Cake | 10.0 | 10.0 | 10.0 | 2.5 |
| Anthracite | 1.67 | 1.82 | 2.0 | 1.85 |
| Coal | | | | |
| FeO | 0.249 | 0.258 | 0.239 | 0.267 |
| Fe₂O₃ | 0.502 | 0.501 | 0.451 | 0.503 |
| MnO₂ | 0.05 | 0.10 | 0.20 | 0.25 |
| Redox Ratio | 0.496 | 0.515 | 0.530 | 0.531 |
| LTA | 74.56 | 73.52 | 75.00 | 73.52 |
| LTC | 77.01 | 75.89 | 77.35 | 76.04 |
| Dominant | 488.8 | 489.1 | 489.5 | 489.6 |
| Wavelength | | | | |
| Excitation | 7.8 | 7.5 | 7.1 | 7.8 |
| Purity, % | | | | |
| % Ultra Violet | 59.99 | 59.54 | 61.56 | 60.01 |
| % Infra Red | 19.51 | 18.50 | 20.68 | 17.58 |
| % Total Solar | 45.12 | 43.99 | 45.90 | 43.48 |
| Energy | | | | |

As can be seen from the examples above, the glass in accordance with the present invention provides for high transmittance, an improved infrared light absorption, and an improved ultraviolet absorption. A unique aqua blue color is obtained that provides a new color option for both automotive and architectural glass applications. In particular, the aqua blue color is defined by a color space substantially contained within a parallelogram bounded by the following x and y chromaticity coordinates: (0.298, 0.316);(0.294, 0.316);(0.294, 0.311); and (0.289, 0.311).

What is claimed is:

1. A colored glass having a base and a colorant, wherein composition of the colorant by weight of the colored glass comprises:
0.4 to 0.6 wt. % Fe₂O₃;
0.18 to 0.28 wt. % FeO;
0.05 to 0.3 wt. % MnO₂; and
0 to 8 ppm Cobalt;
wherein a redox ratio of the weight of FeO to the total weight of iron is in a range of about 0.40 to about 0.58; and
wherein the colored glass has an aqua color with a dominant wavelength of 489.2 nm +/31 1.2 nm, an excitation purity of 7% +/−1%, and an infrared transmittance in the range of 16% to 29% at 4.0 mm thickness.

2. The colored glass of claim 1 wherein a redox ratio of the weight of FeO to the total weight of iron is in a range of about 0.45 to about 0.55.

3. The colored glass of claim 1 wherein the composition of the base by weight of the colored glass includes 1.15 to 2.0 wt. % anthracite coal.

4. The colored glass of claim 1 wherein the composition of the base by weight of the colored glass includes 1.12 to 2.35 wt. % graphite.
